(19) United States
(12) Patent Application Publication
(10) Pub. No.: US 2004/0091307 A1
(43) Pub. Date: May 13, 2004

(54) Structural coupler

(76) Inventor: Thomas A. James, Rockwall, TX (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/294,122

(22) Filed: Nov. 13, 2002

(51) Int. Cl. F16B 7/08

(52) U.S. Cl. 403/188

(57) ABSTRACT

The present invention is directed to a structural coupler having a cross member support tube and an intersecting support tube connected to secure a cross member to a support member to facilitate structural frame assembly. The cross member support tube and the intersecting support tube are connected such that the use of a weld in the construction of the structural coupler is obviated. The structural coupler is formed from a single piece of metal to provide strength and reliability to the point of coupling between the cross member support tube and the intersecting support tube. The structural coupler includes first and second hem couplings for securing the configuration of the structural coupler. The cross member support tube forms a rectangular channel while the intersecting support tube forms a circular channel. A method of manufacturing the structural coupler is provided.

### BACKGROUND OF THE INVENTION

1. The Field of the Invention

The present invention relates to structural couplers. In particular, the present invention relates to a method and apparatus for a structural coupler adapted to secure a cross member to a support member.

2. The Relevant Technology

Frame structures are widely utilized in the design and construction of many engineering developments. Frame structures provide an internal infrastructure to support the components of buildings, apparatuses, and mechanisms. Frame structures are utilized due to the strong and lightweight construction they provide. Frame structures are assembled of interconnected frame members that are juxtaposed to provide the skeleton of the structure. Typical frame structures include cross members arranged in a transverse direction and support members intersecting the cross members. Frames can be utilized for a wide variety of structures and apparatuses including tents, garages, trampolines, gazebos, and the like.

Various mechanism have been developed to couple frame members to one another to facilitate assembly of frame structures. The development of these mechanisms has been particularly important in the market of temporary or adjustable frames. One important example of the mechanisms that have been developed to connect frame members is structural joint couplers. Structural joint couplers vary from generic couplers that can be used in a variety of settings, to couplers tailored to specialized applications. Couplers are often identified according to shape of the coupler, including “T” joints, elbow joints, “J” joints and the like. These couplers are often constructed of metal due to the strength and the relative cost savings realized in using metal joints.

Metal joints are often constructed utilizing welding to produce the angles needed to connect cross members and support members of a structural frame. For example, a first tube is welded perpendicularly to the middle of a second tube to produce a “T” joint. However, when the metal is heated to produce the weld, the strength of the metal is compromised. Additionally, each weld must be produced using either sophisticated machinery or an experienced welding professional. While the use of welding in the construction of couplers can still be more pragmatic than other methods of manufacturing a coupler, the cost of welding can be disproportionate to the cost of the materials utilized in producing the “T” joint.

### BRIEF SUMMARY OF THE INVENTION

The present invention relates to a structural coupler adapted to secure a cross member to a support member. The coupler includes a cross member support tube and a intersecting support tube. The cross member support tube is adapted to accommodate, support, and retain a cross member of a frame structure. The intersecting support tube is adapted to accommodate, support, and retain a support member of a frame structure. The first and second tube are connected permitting the coupler to secure the cross member to the support member to facilitate construction of the frame structure.

According to one aspect of the present invention, the cross member support tube and the intersecting support tube are formed from a single piece of metal.

According to another aspect of the present invention, the cross member support tube and the intersecting support tube are connected such that the use of a weld in the construction of the structural coupler is eliminated.

According to another aspect of the invention, the structural coupler includes first hem coupling and a second hem coupling for securing the configuration of the cross member support tube and the intersecting support tube. The first and second hem couplings obviate the need to weld one or more portions of the structural coupler.

According to another aspect of the invention, the cross member support tube forms a rectangular channel while the intersecting support tube forms a circular channel.

According to another aspect of the invention, a method of manufacturing the structural coupler is provided.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view illustrating the structural coupler according to one aspect of the present invention.

FIG. 2 is a bottom view of the coupler illustrating the intersecting support tube according to one aspect of the present invention.

FIG. 3 is an end view of the coupler illustrating the cross member support tube according to one aspect of the present invention.

FIG. 4 is a side view of the coupler illustrating the first hem coupling and the second hem coupling according to one aspect of the present invention.

FIG. 5 is cross-sectional side view of the coupler illustrating a first and second cross member and a support member according to one aspect of the present invention.

FIG. 6 illustrates a blank from which the coupler can be formed according to one aspect of the present invention.

FIG. 7 illustrates an alternative embodiment of the coupler according to one aspect of the present invention.

FIG. 8 illustrates another alternative embodiment of the coupler according to one aspect of the present invention.

FIG. 9 illustrates yet another alternative embodiment of the coupler according to one aspect of the present invention.

FIG. 10 illustrates a trampoline frame structure in which the coupler can be utilized according to one aspect of the present invention.

FIG. 11 illustrates a removable frame structure in which coupler can be utilized according to one aspect of the present invention.

### DETAILED DESCRIPTION OF THE PREFERRED EMBODIMENTS

The present invention relates to a structural coupler adapted to secure a cross member to a support member. The coupler includes a cross member support tube for accommodating, supporting, and retaining a cross member of a frame structure. The coupler further includes an intersecting support tube for accommodating, supporting, and retaining a support member of a frame structure. The first and second tube are connected permitting the coupler to secure the cross member to the support member.

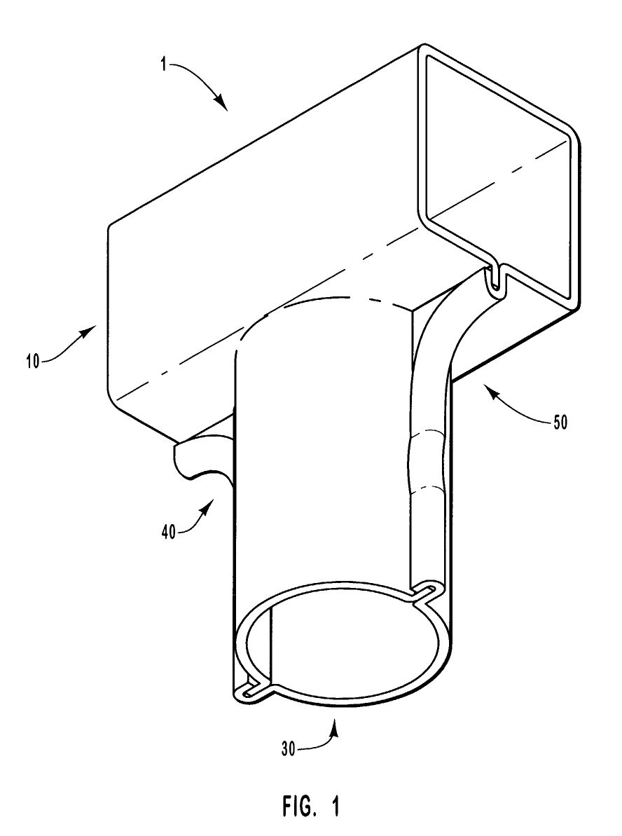

With reference now to FIG. 1, there is shown a perspective view of a coupler 1 according to one aspect of the present invention. In the illustrated embodiment, coupler 1 comprises a structural coupler for securing a first and second cross member to a support member. Coupler 1 is formed from a are formed by folding a single sheet of material and is configured to obviate the use of welding in the construction of coupler 1. In the illustrated embodiment, the single sheet of material comprises a sheet of sheet metal.

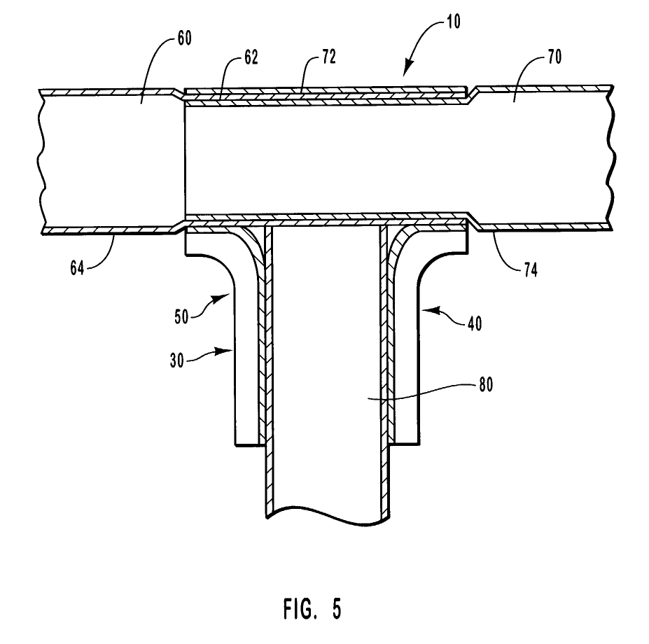

Coupler 1 comprises a cross member support tube 10, an intersecting support tube 30, a first hem coupling 40, and a second hem coupling 50. In the illustrated embodiment, cross member support tube 10 comprises a rectangular member having an outer shell that defines an interior rectangular channel having a substantially constant circumference. Cross member support tube 10 is adapted to receive one or more cross members and to provide a mechanism for coupling the one or more cross members to a support member. In the preferred embodiment cross member support tube 10 is adapted to accommodate, facilitate coupling of, and provide support to a first and second cross member. The rectangular configuration of cross member support tube 10 prevents rotation of the one or more cross members positioned in the cross member support tube 10. A more complete discussion of the manner in which cross member support tube 10 can be utilized to accommodate, facilitate coupling of, and provide support to a first and second cross member will be discussed in greater detail with reference to FIG. 5.

Intersecting support tube 30 is connected to cross member support tube 10. In the illustrated embodiment, intersecting support tube 30 comprises a cylindrical member having an outer shell that defines an interior circular channel having a substantially constant diameter. Intersecting support tube 30 is positioned perpendicularly to cross member support tube 10. Intersecting support tube 30 is configured to accommodate a support member and provide a mechanism for coupling the support member to one or more cross members positioned in cross member support tube 10. The circular configuration of the channel of intersecting support tube 30 permits a cylindrical support member to be positioned internal to the intersecting support tube 30. As previously discussed cross member support tube 10 and intersecting support tube 30 are formed from a single piece of metal. The manner in which intersecting support tube 30 is connected to cross member support tube 10 obviates the need for the use of a weld to secure intersecting support tube 30 and cross member support tube 10.

First hem coupling 40 and second hem coupling 50 are connected to cross member support tube 10 and intersecting support tube 30. First hem coupling 40 and second hem coupling 50 secure the configuration of cross member support tube 10 and intersecting support tube 30. In the preferred embodiment, cross member support 10, intersecting support tube 30, first hem coupling 40, and second hem coupling 50 are formed from a single piece of metal. First hem coupling 40 and second hem coupling 50 obviate the use of welding in the construction of coupler 1.

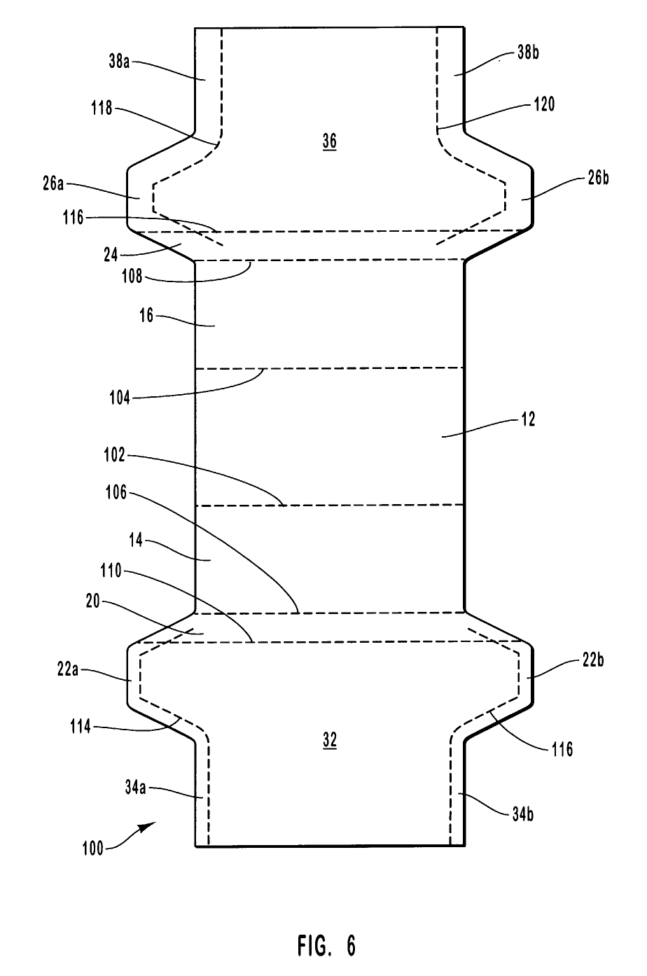

As will be appreciated by those skilled in the art, a variety of types and configurations of coupler 1 can be utilized without departing from the scope or spirit of the present invention. For example, in one embodiment, both cross member support tube 10 and intersecting support tube 30 form circular channels. In another embodiment, both cross member support tube and intersecting support tube form rectangular channels. In another embodiment, coupler 1 comprises a “J” coupler. In another embodiment, first hem coupling 40 and second hem coupling 50 are comprised of a separate piece of metal from the single piece of metal from which cross member support tube 10 and intersecting support tube 30 are formed. In yet another embodiment, at least one of cross member support tube 10 and intersecting support tube 30 comprises a member having an outer shell which defines an internal circular channel having a variable diameter. Additional embodiments of the present invention will be discussed with reference to FIGS. 6, 7 and 8.

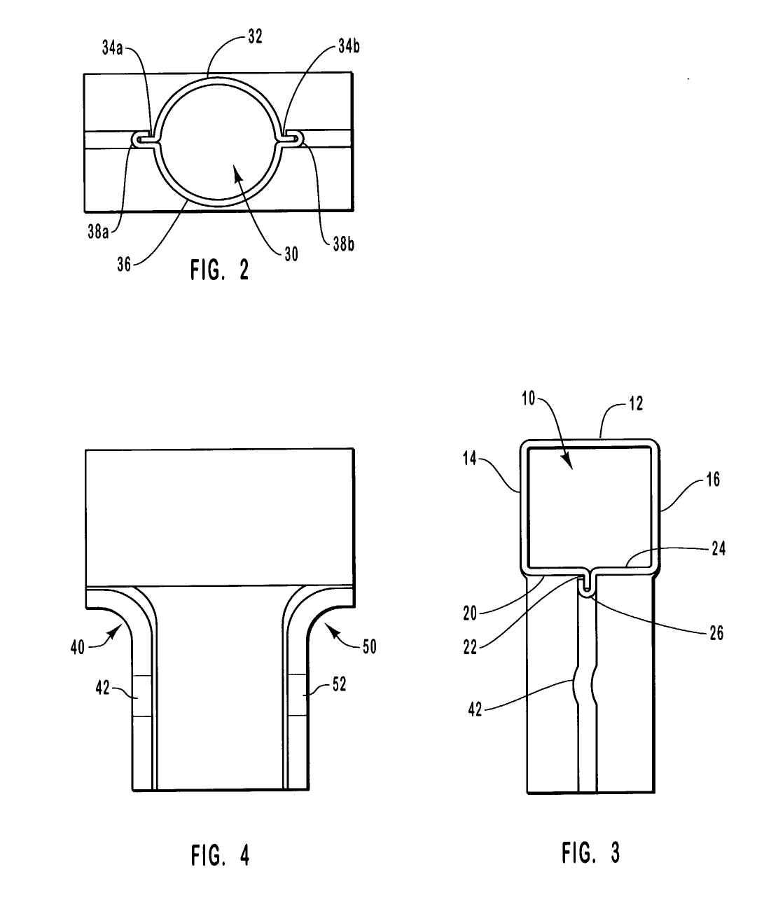

With reference now to FIG. 2, there is shown a bottom view of coupler 1 according to one aspect of the present invention. In the illustrated embodiment, intersecting support tube 30 comprises a first component 32, flanges 34a,b, second component 36, and hems 38a,b. First component 32 comprises a concave member that defines a portion of an interior circular channel of intersecting support tube 30. First component 32 is coupled to flanges 34a,b. Flanges 34a,b project laterally from first component 32 at a 180° angle from one another.

Second component 36 comprises a concave member that defines a portion of the interior channel of intersecting support tube 30. Second component 36 is coupled to hems 38a,b. Hems 38a,b are adjacent to and in contact with flanges 34a,b so as to envelope flanges 34a,b. The configuration of flanges 34a,b and hems 38a,b secures first component 32 to second component 36 forming intersecting support tube 30. Flange 34a and hem 38a form a portion of first hem coupling 40. Flange 34b and hem 38b form a portion of second hem coupling 50.

With reference now to FIG. 3, there is shown an end view of coupler 1 illustrating cross member support tube 10 in greater detail. In the illustrated embodiment, cross member support tube 10 comprises a support tube top 12, a sidewall 14, a sidewall 16, a first bottom component 20, a flange 22, a second bottom component 24, and a hem 26. Support tube top 12, side wall 14, side wall 16, first bottom component 20, and second bottom component 24, comprise the outer shell of cross member support tube 10. Support tube top 12, side wall 14, side wall 16, first bottom component 20, and second bottom component 24, define an interior rectangular channel. The rectangular channel is adapted to accommodate at least one cross member. Support tube top 12, side wall 14, side wall 16, first bottom component 20, second bottom component 24 are formed from a single piece of metal providing strength and reliability to the construction of cross member support tube 10.

Flange 22 is coupled to first bottom component 20. Flange 22 is positioned perpendicularly to first bottom component 20. Hem 26 is coupled to second bottom component 24. Hem 26 is positioned adjacent to and in contact with flange 22 so as to envelope flange 22. The configuration of second bottom component 24 and hem 26 secures first bottom component 20 to second bottom component 24 forming cross member support tube 10. Flange 22 and hem 26 form a portion of first hem coupling 40. In the preferred embodiment, flange 22 and hem 26 are formed from the same piece of metal as support tube top 12, side wall 14, side wall 16, first bottom component 20, and second bottom component 24.

A variety of types and configurations of cross member support tube 10 can be utilized without departing from the scope and spirit of the present invention. For example, in one embodiment, the cross member support tube has an outer shell that defines an interior channel having a circular configuration. In an alternative embodiment, a first and second flange are coupled to the first bottom component and the second bottom component. In the embodiment, a hem member formed from a separate piece of metal connects the first to the second flange to secure first bottom component 20 to second bottom component 24.

There is also shown an anti-slip element 42. Anti-slip element 42 is formed from the portion of first hem coupling 40 comprising flange 34a and hem 38a. Anti-slip element 42 prevents movement of flange 34a relative to hem 38a. In the illustrated embodiment, anti-slip element 42 comprises a stamp providing additional strength to the coupling of flange 34a and hem 38a. A variety of types and configurations of anti-slip element can be utilized without departing from the scope and spirit of the present invention. For example in one embodiment, the anti-slip element comprises a spot weld of hem 38a to flange 34a. In alternative embodiment, the anti-slip element comprises a crimp in flange 34a and hem 38a to prevent movement of flange 34a relative to hem 38a.

With reference now to FIG. 4, there is shown a side view of coupler 1 illustrating the configuration of first hem coupling 40 and second hem coupling 50. First hem coupling 40 and second hem coupling 50 secure the configuration of cross member support tube 10 and intersecting support tube 30. First hem coupling 40 and second hem coupling 50 obviate the use of welding in the construction of coupler 1. In the illustrated embodiment, first hem coupling 40 includes anti-slip element 42 and second hem coupling 50 includes anti-slip element 52. For a more complete discussion of anti-slip element 42 please refer to the description of FIG. 3. The configuration and functionality of anti-slip element 52 is analogous to anti-slip element 42 described with reference to FIG. 3.

The configuration of first hem coupling 40 and second hem coupling 50 facilitates the uniform construction of cross member support tube 10, while obviating the use of welding in the construction of coupler 1. Additional strength is imparted to the construction of coupler 1 due the weldless construction of coupler 1 and due to the fact that cross member support tube 10, intersecting support tube 30, first hem coupling 40, and second hem coupling 50 are formed from a single piece of metal. The additional strength increases the reliability and longevity of coupler 1, particularly at the point of connection between cross member support tube 10 and intersecting support tube 30.

With reference now to FIG. 5, there is shown coupler 1 illustrating the manner in which coupler 1 can be utilized to secure a first and second cross member to a support member according to one aspect of the present invention. In the illustrated embodiment, coupler 1 is utilized with a cross member 60, a cross member 70, and a support pole 80. Cross member 60 comprises a coupling segment 62 and a rail segment 64. Cross member 70 also comprises a coupling segment 72 and a rail segment 74. Coupling segments 62 and 72 are positioned in the channel of cross member support tube 10. Rail segment 64 and 74 are positioned external to the channel of cross member support tube 10.

The configuration of coupling segments 62 and 72 permits cross member 60 and 70 to be connected. In the illustrated embodiment, coupling segment 62 comprises a female member while coupling segment 72 comprises a male member. Coupling segment 72 is positioned internal to coupling segment 62 to connect cross member 70 to cross member 60. Cross member support tube 10 provides additional support to the point of coupling between coupling segment 62 and coupling segment 72 providing increased strength and reliability to cross member 60 and cross member 70.

Coupler 1 secures first and second cross members 60 and 70 to a support pole 80. Support pole 80 is positioned inside the channel formed by intersecting support tube 30. Support pole 80 is one example of a support member. Cross members 60 and 70 are positioned in cross member support tube 10. The configuration of cross member support tube 10 and intersecting support tube 30 secures cross members 60 and 70 to support pole 80 in a strong and reliable manner. Additionally, by eliminating the need to use welding in both the construction of coupler 1 and at the points of coupling between coupler 1, cross member 60, cross member 70, and/or support pole 80; coupler 1 provides a quick and efficient mechanism for coupling cross member 60, cross member 70, and support pole 80 relative to one another.

With reference now to FIG. 6, there is shown a blank 100 from which coupler 1 is formed. In the illustrated embodiment, blank 100 comprises a single piece of metal. In the illustrated embodiment there is shown fold lines 102, 104, 106, 108, 110, 112, 114, 116, 118, and 120. Fold lines 102, 104, 106, 108, 110, 112, 114, 116, 118, 120 are included for reference and are not necessarily present in blank 100 prior to folding of blank 100 during manufacture of coupler 1. Fold lines 102, 104, 106, 108, 110, 112, 114, 116, 118, and 120 represent the boundaries along which blank 100 will be folded to form the outer shell of the components of coupler 1.

Cross member support tube 10 is comprised of the portion of blank 100 positioned between fold lines 110 and 112. As discussed with reference to FIG. 3, cross member support tube comprises support tube top 12, side wall 14, side wall 16, first bottom component 20, flange 22, second bottom component 24, and hem 26. Support tube top 12 is formed from the portion of blank 100 positioned between fold lines 102 and 104. Side wall 14 is formed from the portion of blank 100 positioned between fold lines 102 and 106. Side wall 16 is formed from the portion of blank 100 positioned between fold line 104 and 108. First bottom component 20 is formed from the portion of blank 100 positioned between fold lines 106 and 110. Second bottom component 24 is formed from the portion of blank 100 positioned between fold lines 108 and 112. Flanges 22a and 22b are formed from a portion of blank 100 positioned laterally to fold lines 114 and 116. Hems 26a and 26b are formed from a portion of blank 100 positioned laterally to fold lines 118 and 120.

Intersecting support tube 30 is formed from the portion of blank 100 positioned distally from fold lines 110 and 112. As discussed with reference to FIG. 2, intersecting support tube 30 comprises a first component 32, flanges 34a,b, second component 36, and hems 38a,b. First component 32 is formed from the portion of blank 100 positioned distally to fold line 110 and between fold lines 114 and 116. Second component 36 is formed from the portion of blank 100 positioned distally to fold line 112 and between fold lines 118 and 120. Flange 34a is formed from a portion of blank 100 positioned distally to fold line 114. Flange 34b is formed from a portion of blank 100 positioned distally to fold line 116. Hem 38a is formed from a portion of blank 100 positioned distally to fold line 118. Hem 38b is formed from a portion of blank 100 positioned distally to fold line 120.

First hem coupling 40 is comprised of the portion of blank 100 positioned laterally to fold lines 118 and 114. As previously discussed, first hem coupling 40 comprises flange 22a, hem 26a, flange 34a, and hem 38a. Second hem coupling 50 is comprised of the portions of blank 100 positioned laterally to fold lines 116 and 120. As previously discussed, first hem coupling 40 comprises flange 22b, hem 26b, flange 34b, and hem 38b. The configuration of first hem coupling 40 and second hem coupling 50 facilitates the uniform construction of coupler 1 while obviating the use of welding in the construction of coupler 1. A variety of types and configurations of blank 1 can be utilized without departing from the scope and spirit of the present invention. For example, in one example the blank comprises a single piece of stamped sheet metal. In an alternative configuration, the blank is formed from a polymer composite material.

The presently preferred method of manufacturing coupler 1 will now be described in relation to the embodiment shown in FIGS. 1-6. Blank 100 is produced having the form shown in FIG. 6 according to known methods. In the preferred embodiment, blank 100 is stamped from a quantity of sheet metal of a desired width. Next first component 32 and second component 36 are fashioned by forming the concave members illustrated in FIG. 2 according to known methods. Next flanges 34a,b and hem 38a,b are folded perpendicularly to first component 32 and second component 36, while flanges 22a,b and hems 26a,b are folded relative to first bottom component 20 and second bottom component 24 by folding along fold lines 114, 116, 118, and 120. Cross member support tube 10 is then formed by folding along fold lines 102, 104, 106, 108, 110, and 112.

As blank 100 is folded along lines 110 and 112 forming cross member support tube 10, first component 32, and second component 36 are also positioned adjacent one another forming intersecting support tube 30. Similarly, flange 22a is positioned adjacent hem 26a, flange 22b is positioned adjacent hem 26b, flange 34a is positioned adjacent hem 38a, and flange 34b is positioned adjacent hem 38b. Once hems 26a,b- and 38a,b are positioned adjacent flanges 22a,b and 34a,b, first hem coupling 40 and second hem coupling 50 are formed, securing the configuration of cross member support tube 10 and intersecting support tube 30. Once first hem coupling 40 and second hem coupling 50 have been formed, anti-slip element 42 and anti-slip element 52 are formed according to known methods.

In one embodiment, first hem coupling 40 and second hem coupling 50 are formed simultaneously. In the embodiment, once flanges 22a,b and flanges 34a,b are positioned adjacent hems 26a,b and 38a,b, a portion of hems 26a,b extend beyond flanges 22a,b and a portions of hems 38a,b extend beyond flanges 34a,b. The portions extending beyond the flanges are then folded at right angles such that a portion of hems 26a,b are positioned in contact with and over the top of flanges 22a,b and a portion of hems 38a,b are positioned in contact with and over the top of flanges 34a,b. Hems 26a,b and 38a,b are then folded over flanges 22a,b and 34a,b, enveloping and contacting the opposite side of flanges 22a and b and 34a and b.

A variety of methods and mechanisms can be utilized to manufacture coupler 1 without departing from the scope and spirit of the present invention. For example, in 40 and second hem coupling 50. According to one preferred embodiment of the present steps. The first step positions hems 26a,b and 38a,b at right angles so as to contact the top of flanges 22a,b and 34a,b. In the embodiment, a second step utilizes a single camming action in the direction of the angles formed at the junctions of cross member support tube 10 and intersecting support tube 30 where flanges 22a,b and flanges 34a,b meet. The camming action uniformly and in a single movement forces hems 26a,b and hems 38a,b around the second side flanges 22a,b and 34a,b enveloping flanges 22a,b and 34a,b.

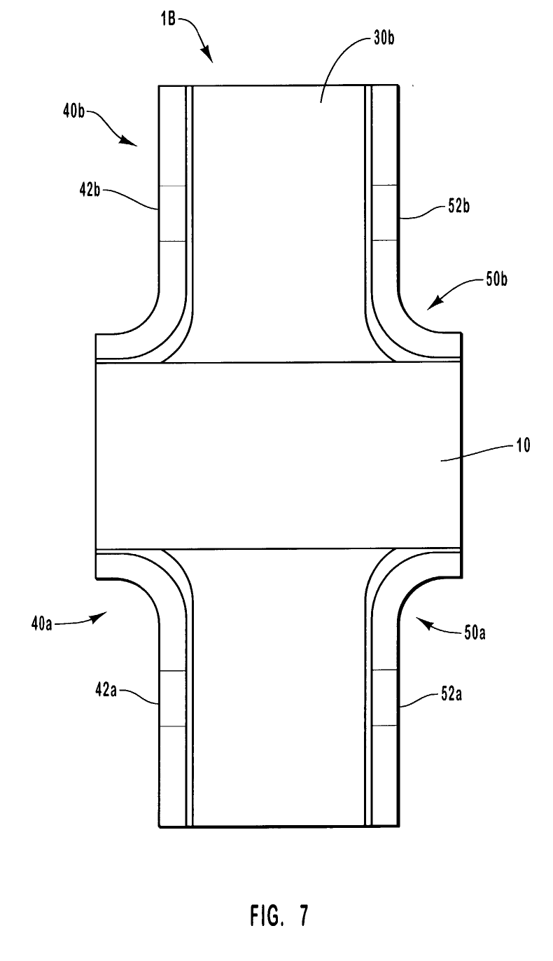

With reference now to FIG. 7, there is shown a coupler lB according to one aspect of the present invention. In the illustrated embodiment coupler lB comprises a cross member support tube 10, an intersecting support tube 30a, and an intersecting support tube 30b. Cross member support tube 10 comprises a rectangular member having an outer shell that defines an interior channel having a substantially constant circumference. Cross member support tube 10 can accommodate one or more cross members.

Intersecting support tube 30a comprises a cylindrical member having an outer shell which defines an interior circular channel having a substantially constant diameter. Intersecting support tubes 30a can accommodate a support member permitting the support member to be coupled to the one or more cross members. Intersecting support tube 30b comprises a cylindrical member having an outer shell that defines an interior circular channel having a substantially constant diameter. Intersecting support tubes 30a can accommodate a support member permitting the support member to be coupled to the one or more cross members. The channels of cross member support tube 10, intersecting support tube 30a, and intersecting support tube 30b are connected forming a chamber internal to coupler 1B. By forming a chamber internal to coupler 1B, cross member support tube 10 and support tubes 30a,b allow support members to be positioned adjacent to, and in contact with, the one or more cross members.

In the illustrated embodiment, hem couplings 40a, 40b, 50a, and 50b are utilized. Hem couplings 40a, 40b, 50a, and 50b are utilized to connect cross member support tube 10, intersecting support tube 30a, and intersecting support tube 30b. Hem coupling 40a includes anti-slip element 42a. Hem coupling 40b includes anti-slip element 42b. Hem coupling 50 includes anti-slip element 52a. Hem coupling 50 includes anti-slip element 52b. In the illustrated embodiment, coupler 1B is comprised of two separate pieces of metal connected utilizing hem couplings 40a, 40b, 50a, and 50b. In an alternative embodiment, coupler 1B is comprised of a single piece of metal.

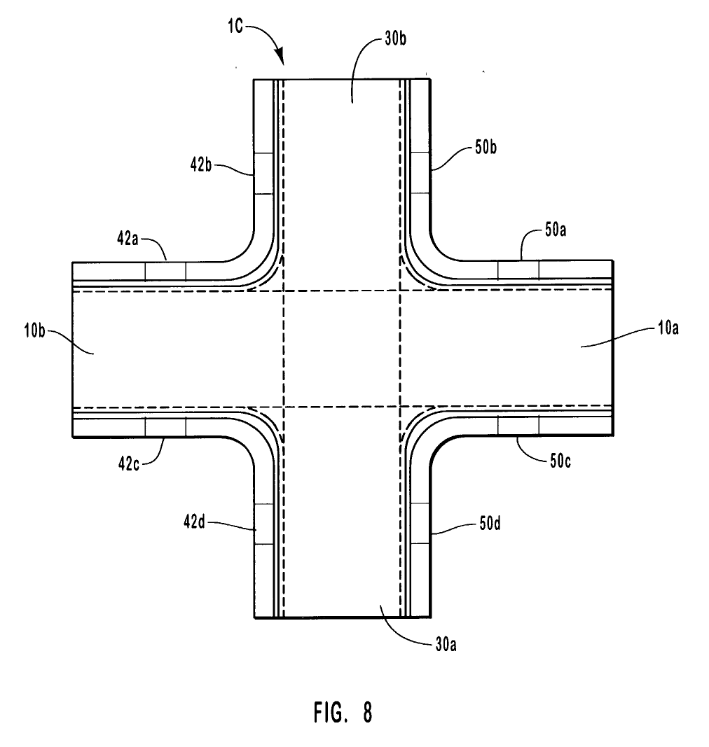

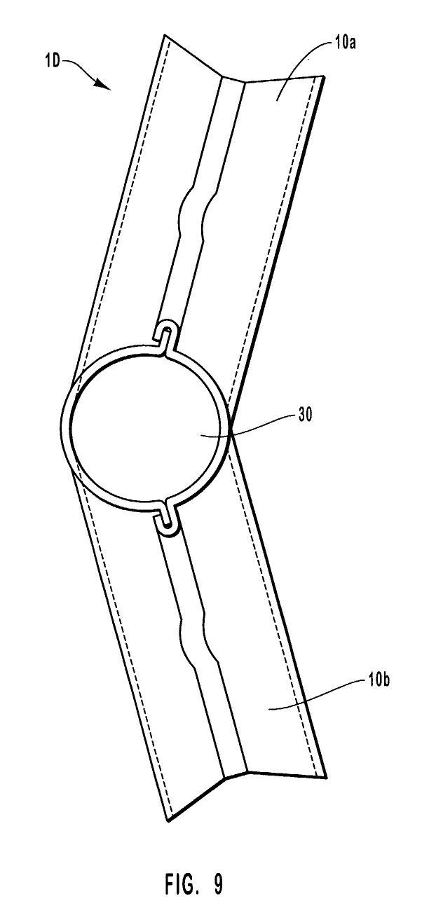

With reference now to FIG. 8, there is shown a coupler 1C according to one aspect of the present invention. In the illustrated embodiment coupler 1C includes a cross member support tube 10a, a cross member support tube 10b, an intersecting support tube 30a, and an intersecting support tube 30b. In the illustrated embodiment, cross member support tubes 10a and 10b comprise cylindrical members having an outer shell which defines an interior circular channel having a substantially constant diameter. Similarly, intersecting support tubes 30a,b comprise cylindrical members having an outer shell which defines an interior circular channel having a substantially constant diameter. The configuration of cross member support tube 10a, cross member support tube 10b, intersecting support tube 30a, and intersecting support tube 30b permit three to four cross member/support members to be connected to one another. In the embodiment, anti-slip elements 42a, 42b, 42c, 42d, 50a, 50b, 50c, and 50d are utilized to prevent movement of the flanges of coupler 1C relative to the hems of coupler 1C.

With reference now to FIG. 9, there is shown yet another embodiment of coupler ID according to one aspect of the present invention. In the illustrated embodiment, coupler 1D comprises a cross member support tube 10a, a cross member support tube 10b, and an intersecting support tube 30. Cross member support tube 10a and cross member support tube 10b are connected to intersecting support tube 30. In the illustrated embodiment, cross member support tube 10a is positioned at an angle relative to cross member support tube 10b. A plurality of embodiments of coupler 1 are illustrated in FIGS. 1, 6, 7, and 8. FIGS. 1, 6, 7 and 8 provide exemplary embodiments of the present invention and should not be considered to be limiting in scope. A variety of types and configurations of coupler 1 can be utilized without departing from the scope or spirit of the present invention.

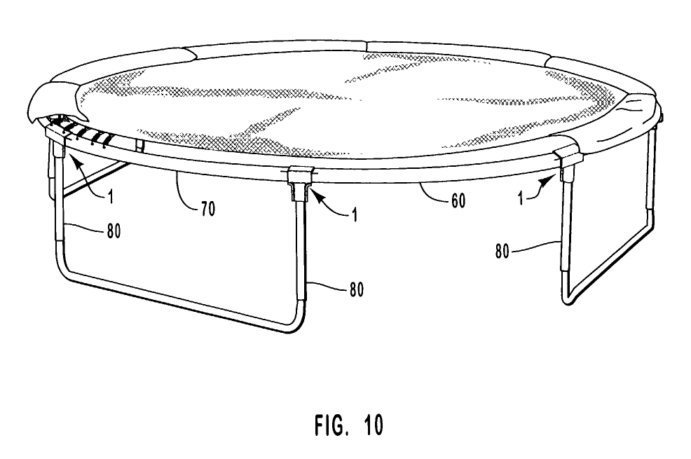

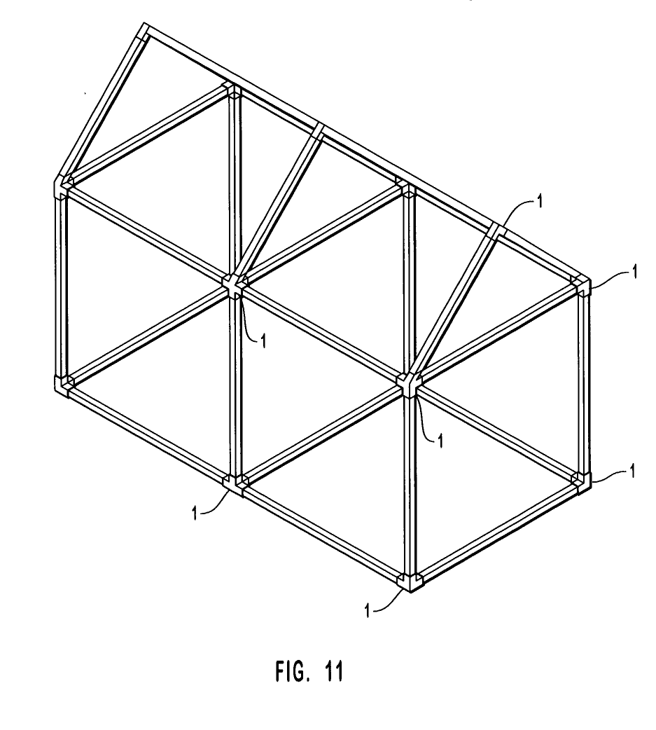

With reference now to FIG. 10, there is shown a plurality of couplers 1 illustrating an application in which couplers 1 can be utilized. In the illustrated embodiment, couplers 1 are utilized to secure rail members and leg supports of a trampoline to form a trampoline frame. Couplers 1 facilitate assembly of the trampoline by providing a mechanism for quickly and efficiently connecting cross members 60 and 70 and support poles 80. Additionally, the configuration of couplers 1 provides additional strength and reliability to the frame of the trampoline. The strength and reliability provided to the trampoline by coupler 1 is due to the fact that coupler 1 utilizes a hem for securing cross member support tubes and intersecting support tubes, is assembled of a single piece of metal, and obviates the use of welding in the construction coupler 1. Additionally, coupler 1 provides strength and reliability to the trampoline by providing additional support to the point of coupling between cross member 60 and cross member 70.

With reference now to FIG. 1I, there is shown another application in which coupler 1 can be utilized according to one aspect of the present invention. In the illustrated embodiment, couplers 1 are utilized with cross members and support members to form a frame of a structure such as a carport, tent, or gazebo. It can be seen that a variety of types and configurations of couplers 1 are utilized to form the structure. It will be appreciated, that the variety of types and configurations of coupler 1 provide a user with flexibility in constructing a variety of types and configurations of structures, mechanisms, and apparatuses. For a more complete discussion of the types of couplers utilized in FIG. 9 please refer to the discussion of FIGS. 1, 6, 7, and 8.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A structural coupler for securing a first and second cross member to a support member, the structural coupler comprising:
a cross member support tube; and
an intersecting support tube positioned perpendicular to the cross member support tube, wherein the cross member support tube and the intersecting support tube are formed by folding a single sheet of material.

2. The structural coupler of claim 1, wherein the coupler comprises a “J” joint coupler.

3. The structural coupler of claim 1, wherein the coupler comprises a “T” joint coupler.

4. The structural coupler of claim 1, wherein the coupler comprises an elbow joint coupler.

5. The structural coupler of claim 1, wherein the cross member support tube comprises a rectangular member having an outer shell that defines an interior rectangular channel having a substantially constant circumference.

6. The structural coupler of claim 1, wherein the cross member is adapted to accommodate a first and second cross member.

7. The structural coupler of claim 6, wherein the intersecting support tube accommodates a support member to secure the support member to the first and second cross members positioned in the cross member support tube.

8. The structural coupler of claim 1, wherein the intersecting support tube comprises a cylindrical member having an outer shell that defines an interior channel having a substantially constant diameter.

9. The structural coupler of claim 1, further comprising a first hem coupling and a second hem coupling.

10. The structural coupler of claim 9, wherein the first hem coupling and the second hem coupling secure the configuration of the cross member support tube and the intersecting support tube.

11. The structural coupler of claim 10, wherein the first hem coupling and the second hem coupling obviate the use of welding in the construction of the coupler.

12. The structural coupler of claim 1, wherein the single piece of material comprises a blank formed from a single piece of sheet metal

13. The structural coupler of claim 1, wherein the single piece of material comprises a blank formed from a single piece polymer composite material.

14. The structural coupler of claim 1, wherein the structural coupler facilitates assembly of a trampoline frame.

15. The structural coupler of claim 1, wherein the structural coupler facilitates assembly of a temporary structure.

16. A structural coupler having a weldless construction and being adapted to secure a first and second cross member to a support member, the structural coupler comprising:
a cross member support tube having a weldless construction; and
an intersecting support tube having a weldless construction and being positioned perpendicular to the cross member support tube, wherein the intersecting support tube and the cross member support tube are formed by folding a single sheet of material such that the use of a weld is obviated.

17. The structural coupler of claim 16, wherein the weldless construction of the structural coupler provides additional strength to the point of coupling between the cross member support tube and the intersecting support tube.

18. The structural coupler of claim 16, wherein the cross member support tube and the intersecting support tube form circular channels.

19. The structural coupler of claim 16, wherein the cross member support tube and the intersecting support tube form rectangular channels

20. The structural coupler of claim 16, wherein at least one of the cross member support tube and the intersecting support tube comprises a member having an outer shell that defines an interior channel having a variable diameter.

21. The structural coupler of claim 16, wherein the structural coupler further comprises an additional intersecting support tube connected to the cross member support tube.

22. The structural coupler of claim 16, wherein the structural coupler further comprises an additional cross member support tube connected to the intersecting support tube.

23. The structural coupler of claim 22, wherein the additional cross member support tube is positioned at an angle relative to the cross member support tube.

24. A structural coupler for securing a first and second cross member to a support member, the structural coupler comprising:
a cross member support tube;
an intersecting support tube positioned perpendicular to the cross member support tube; and
a first and second hem coupling securing the configuration of the cross member support tube and the intersecting support tube, the first and second hem coupling obviating the need to use welding in the construction of structural coupler.

25. The structural coupler of claim 24, wherein the cross member support tube, the intersecting support tube, the first hem coupling, and the second hem coupling are formed from a single piece of metal.

26. The structural coupler of claim 24, wherein the first hem coupling and the second hem coupling are comprised of a separate piece of metal from the single piece of metal comprising the cross member support tube and the intersecting support tube.

27. The structural coupler of claim 24, wherein the first hem coupling and second hem coupling include an anti-slip element.

28. The structural coupler of claim 27, wherein the anti-slip element prevents movement of a flange relative to a hem, wherein the flange and the hem comprise one of the first and second hem couplings.

29. The structural coupler of claim 28, wherein the anti-slip element comprises a stamp to the coupling of the flange relative to the hem.

30. The structural coupler of claim 27, wherein the anti-slip element comprises a spot weld between the flange and the hem.

31. The structural coupler of claim 27, wherein the anti-slip element comprises a crimp in the first and second hem couplings.

32. A structural coupler for securing a first and second cross member to a support member, the structural coupler comprising:
a cross member support tube forming a rectangular channel; and
an intersecting support tube forming a circular channel, wherein the intersecting support tube is connected to the cross member in a substantially perpendicular fashion.

33. The structural coupler of claim 32, wherein the intersecting support tube comprises a first component, first and second flanges, a second component, and first and second hems.

34. The structural coupler of claim 33, wherein the first component and second component comprise concave members that define the interior circular channel of intersecting support tube.

35. The structural coupler of claim 32, wherein the cross member support tube comprises a support tube top, a first sidewall, a second sidewall, a first bottom component, a flange, a second bottom component, and a hem.

36. The structural coupler of claim 35, wherein the support tube top, the first side wall, the second side wall, the first bottom component, and the second bottom component, comprise an outer shell of cross member support tube.

37. A method of manufacturing a structural coupler adapted to secure a first and second cross member to a support member, the method of manufacture comprising:
providing a quantity of sheet of metal of a desired width;
forming a blank from the quantity of sheet metal;
forming a cross member support tube from a portion of the blank;
forming an intersecting support tube from a portion of the blank such that the intersecting support tube is positioned perpendicular to the cross member support tube; and
forming a first and second hem coupling from a portion of the blank to secure the configuration of the cross member support tube and the intersecting support tube.

38. The method of claim 37, wherein forming a blank from the quantity of sheet metal comprises stamping a blank from the quantity of sheet metal.

39. The method of claim 37, wherein forming an intersecting support tube comprises forming a first concave component and a second concave component and subsequently connecting the first concave component and the second concave component to form the intersecting support tube.

40. The method of claim 39, wherein forming a first concave component and a second concave component is executed before the cross member support tube is formed.

41. The method of claim 37, further comprising forming flanges.

42. The method of claim 41, further comprising forming hems.

43. The method of claim 42, wherein forming a first and second hem coupling from a portion of the blank comprises forming a first and second hem coupling from the flanges and the hems.

44. The method of claim 42, wherein the first hem coupling and the second hem coupling are formed simultaneously.

45. The method of claim 44, wherein the first hem coupling and the second hem coupling comprises folding the hems such that the hems contact the top of the flanges and further comprises utilizing a single camming action to fold the hems around the flanges.

46. The method of claim 45, wherein the camming action is performed in the direction of the angle formed at the junction of the cross member support tube and the intersecting support tube.

47. The method of claim 45, wherein the camming action uniformly and in a single movement forces the hems around the flanges enveloping the flanges.

48. The method of claim 37, further comprising forming an anti-slip element in first and second couplings.

49. A structural coupler for securing a first and second cross member to a support member, the structural coupler comprising:
a cross member support tube forming a rectangular channel;
an intersecting support tube forming a circular channel, the intersecting support tube being positioned perpendicular to the cross member support tube; and
a first and second hem coupling securing the configuration of the cross member support tube and the intersecting support tube, the first and second hem coupling obviating the use of welding to secure one or more portions of the structural coupler, wherein the cross member support tube, the intersecting support tube, and the first and second hem couplings are formed from a single piece of metal.

50. The structural coupler of claim 49, wherein the rectangular channel of the cross member support tube prevents rotation of the one or more cross members positioned in the cross member support tube.

51. The structural coupler of claim 49, wherein the cross member support tube is configured to accommodate and support coupling segments of a first and second cross member.

52. The structural coupler of claim 51, wherein the coupling segments of the first and second cross members permit the first and second cross members to be connected.

53. The structural coupler of claim 52, wherein the coupling segment of the first cross member comprises a female member and the coupling segment of the second cross member comprises a male member.

54. The structural coupler of claim 53, wherein the male member is positioned internal to the female member.

55. The structural coupler of claim 54, wherein the cross member support tube provides additional support to the point of coupling between the coupling segment of the first cross member and the coupling segment of the second cross member.
